(19) United States
(12) Patent Application Publication
(10) Pub. No.: US 2017/0075553 A1
(43) Pub. Date: Mar. 16, 2017

(54) METHOD OF CONTROLLING INDICATION, USER TERMINAL DEVICE, AND INDICATION CONTROL PROGRAM

(71) Applicant: LINE Corporation, Tokyo (JP)

(72) Inventor: KENICHI UENO, Tokyo (JP)

(21) Appl. No.: 15/069,026

(22) Filed: Mar. 14, 2016

(30) Foreign Application Priority Data
Sep. 15, 2015 (JP) 2015-182021

(51) Int. Cl. G06F 3/0484

(52) U.S. Cl. CPC G06F 3/04847; G06F 3/04842

(57) ABSTRACT

A method of controlling indication is executed by a user terminal device when displaying predetermined indication information on a display unit showing an operational area on which an operation from a user can be received. The method includes adjusting the indication information so as to prevent the operation from the user on the operational area, from being hindered by the indication information.

### FIELD

The following disclosure generally relates to a method of controlling indication, a user terminal device, and an indication control program.

### BACKGROUND

Nowadays, information processing terminals have functions to display indication information on demand, on a part of a display unit when new information needs to be indicated to users. Japanese Laid-open Patent Publication No. 2014-164682 describes a technology that displays event information, such as reception of e-mail and missed calls, for a user.

Also, Japanese Laid-open Patent Publication No. 2010-108145 describes a technology with which a user can select menus not to be displayed among menus displayed on an LCD monitor so that a mobile terminal displays menus that are easy to use for the user.

However, such indication information may be displayed on the display abruptly for the user, and hence, for example, if the user is using an information processing terminal, the indication information may suddenly appear on a screen currently shown on the display. Therefore, for example, if the indication information appears when the user is about to operate operational buttons shown on the display of the information processing terminal, the operational buttons may be covered by the indication information and become invisible, which is a problem for the user in that he/she cannot operate the operational buttons. In such a case, the user needs to wait until the indication information disappears, or needs to perform an additional operation to erase the indication information by touching the indication information or the like.

Also, there is another problem that, for example, if the indication information is displayed just when the user operates an operational button shown on the display of the information processing terminal, the operation intended to be performed on the operational button may be replaced with an operation on the indication information.

In view of the above, it is a general object of at least one embodiment to provide a method of controlling indication and a user terminal device, with which an operation intended by the user is not hindered when the indication information is displayed for the user.

### SUMMARY

According to an embodiment, a method of controlling indication is executed by a user terminal device when displaying predetermined indication information on a display unit showing an operational area on which an operation from a user can be received. The method includes adjusting the indication information so as to prevent the operation from the user on the operational area, from being hindered by the indication information.

Also, according to another embodiment, a user terminal device includes an indication control unit configured, when displaying predetermined indication information on a display unit showing an operational area on which an operation by a user can be received, to adjust the indication information so as to prevent the operation from the user on the operational area, from being hindered by the indication information.

Note that effective embodiments of the present invention include any combination of elements of the embodiments, and a method, an apparatus, a system, a recording medium, and a computer program obtained by converting the embodiments.

According to the embodiments, an operation intended by the user is not hindered when the indication information is displayed for the user.

### BRIEF DESCRIPTION OF DRAWINGS

FIG. 1 is a block diagram that illustrates an example of a hardware configuration of a user terminal device according to an embodiment;

FIG. 2 is a block diagram that illustrates an example of a functional configuration of a user terminal device according to an embodiment;

FIG. 3 is a diagram that illustrates an example of a display screen according to an embodiment;

FIG. 4 is a diagram that illustrates an example of a display screen according to an embodiment;

FIG. 5 is a diagram that illustrates an example of a display screen according to an embodiment;

FIG. 6 is a diagram that illustrates an example of a display screen according to an embodiment;

FIG. 7 is a diagram that illustrates an example of a display screen according to an embodiment;

FIG. 8 is a diagram that illustrates an example of a display screen according to an embodiment;

FIG. 9 is a diagram that illustrates an example of a display screen according to an embodiment;

FIG. 10 is a diagram that illustrates an example of a display screen according to an embodiment;

FIG. 11 is a diagram that illustrates an example of a display screen according to an embodiment;

FIGS. 12A-12D are diagrams that illustrate examples of display screens according to an embodiment;

FIG. 13 is a diagram that illustrates an example of an internal configuration of an adjustment method storage unit according to an embodiment;

FIG. 14 is a flowchart that illustrates an example of a method of controlling indication according to an embodiment; and

FIG. 15 is a flowchart that illustrates another example of a method of controlling indication according to an embodiment.

### DESCRIPTION OF EMBODIMENTS

In the following, embodiments will be described with reference to the drawings. Note that throughout the specification and the drawings, elements having substantially the same functions and/or configurations are assigned the same codes, to avoid duplicated description.

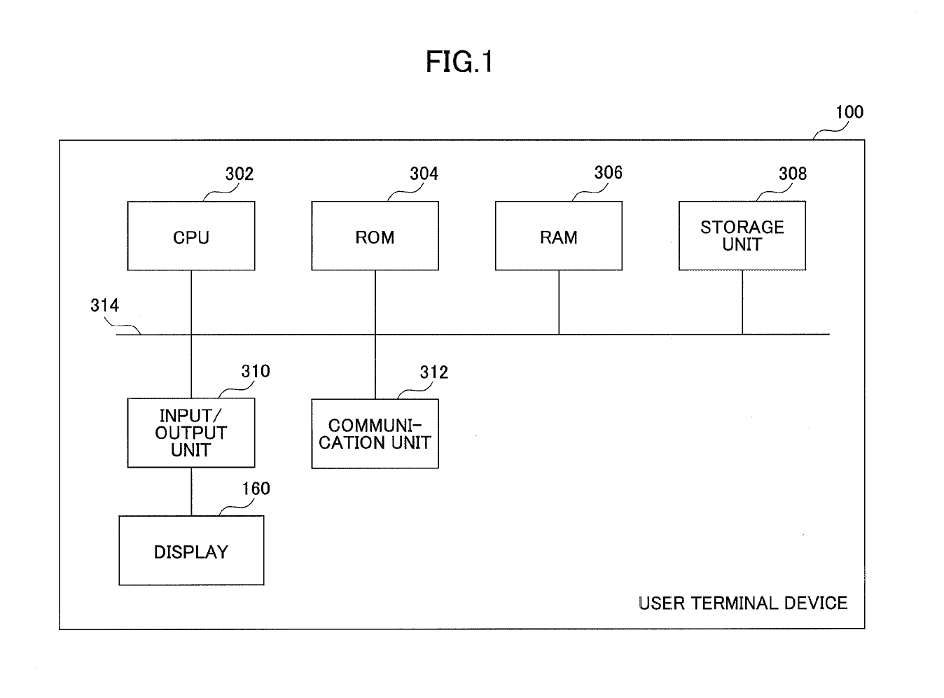

FIG. 1 is a block diagram that illustrates an example of a hardware configuration of a user terminal device 100 according to an embodiment.

The user terminal device 100 is an information processing apparatus, for example, a cellular phone, a smart phone, a game console, a personal computer, a touch pad, an electronic book reader, a wearable terminal, and the like.

The user terminal device 100 includes a CPU (Central Processing Unit) 302, a ROM (Read-Only Memory) 304, a RAM (Random Access Memory) 306, a storage unit 308, an input/output unit 310, a communication unit 312, and a display 160 (a display unit). Note that these units of the user terminal device 100 are mutually connected with via a bus 314.

The storage unit 308 stores various programs. The CPU 302 is a computer to execute the various programs stored in the storage unit 308.

The ROM 304 is a non-volatile memory. The ROM 304 stores various programs, data, and the like that are necessary for the CPU 302 to execute the various programs stored in the storage unit 308.

The RAM 306 is a main memory unit such as a DRAM (Dynamic Random Access Memory) and a SRAM (Static Random Access Memory). The RAM 306 functions as a work area in which the various programs are loaded when executed by the CPU 302.

The input/output unit 310 includes functions of an input unit to input various commands into the user terminal device 100, and an output unit to output a processed result processed by the user terminal device 100. The input/output unit 310 is connected with the display 160. In the embodiment, the display 160 may be a touch-sensitive display (a touch panel). The communication unit 312 executes communication between the user terminal device 100 and other terminals via a network (not illustrated).

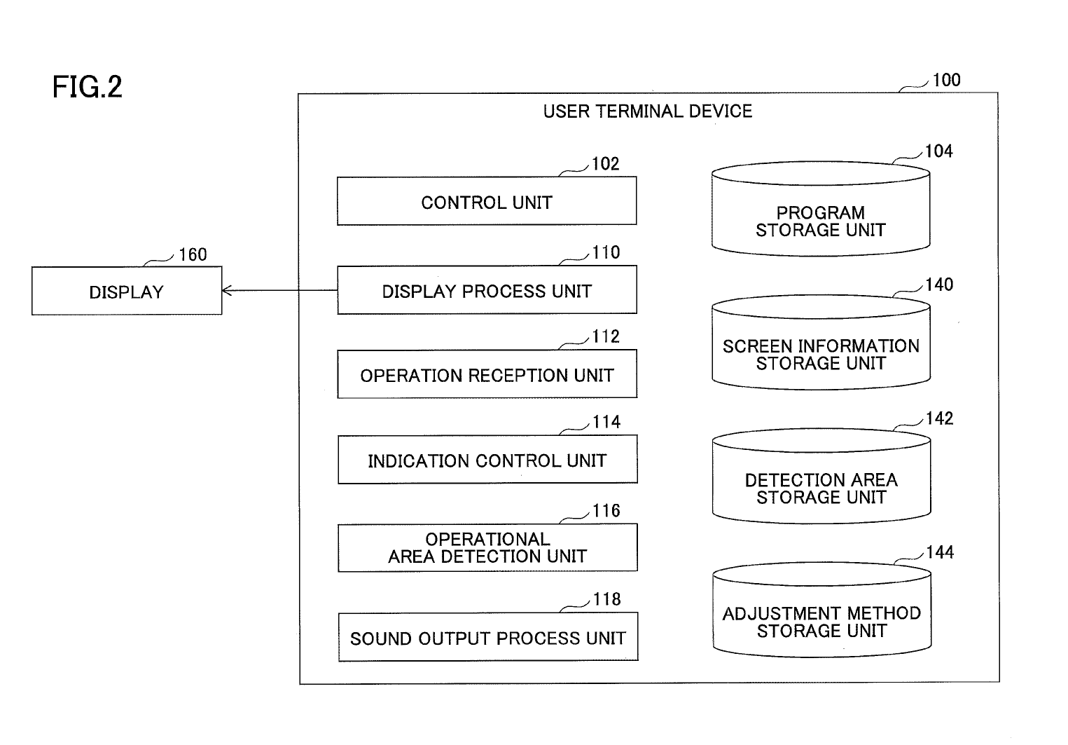

FIG. 2 is a block diagram that illustrates an example of a functional configuration of the user terminal device 100 according to the embodiment.

The user terminal device 100 includes a control unit 102, a program storage unit 104, a display process unit 110, an operation reception unit 112, an indication control unit 114, an operational area detection unit 116, a sound output process unit 118, a screen information storage unit 140, a detection area storage unit 142, and an adjustment method storage unit 144.

The program storage unit 104 stores various programs such as an OS (Operating System) and application programs run on the user terminal device 100. The program storage unit 104 also stores an indication control program that executes an indication control process as will be described below. The functional units of the user terminal device 100 can be implemented by the indication control program.

The control unit 102 controls the user terminal device 100 as a whole. The control unit 102 executes the various programs stored in the program storage unit 104.

The display process unit 110 executes a process for displaying various screens on the display 160. A screen displayed by the display process unit 110 includes an operational area in which an operation from the user can be received. The operational area includes, for example, a button element such as various operational buttons, an input element such as an input box, and link information to other pages and sites, with which the user can perform user-initiated interactive operations on the user terminal device 100.

The operation reception unit 112 receives an operation from the user of the user terminal device 100. In the embodiment, the operation reception unit 112 receives an operation such as touching from the user on the operational area included in a screen shown on the display 160. In the following description, the user operation is mostly assumed to be a touching operation on the display 160. The sound output process unit 118 outputs information by various sounds.

The screen information storage unit 140 stores information about a screen currently shown on the display 160 by the display process unit 110. The information about a screen includes information about various display elements, which are collections of pixels on the screen to represent respective objects, for example, background, an image, a game character, a button element such as various operational buttons, an input element such as an input box, text, and the like on the screen. Information about a display element includes the function, position, and size of the display element. Although it depends on the configuration of a program, the screen information storage unit 140 can store information about the display elements included in the screen by a tree structure. Note that the information about a screen may be configured to be temporarily stored in the screen information storage unit 140 under control of the control unit 102, based on a program read out from the program storage unit 104 when the display process unit 110 displays the screen on the display 160.

The indication control unit 114 detects an occurrence of an event that needs to be indicated to the user. If detecting such an occurrence of an event, the indication control unit 114 executes a process to indicate it to the user. An event that needs to be indicated to the user is, for example, a reception of a message from another user using an application program such as an SNS (Social Networking Service) application installed on the user terminal device 100 by the user, an occurrence of an action by the other user, a reception of e-mail, an absence indication, an alarm, and the like.

In the embodiment, the indication control unit 114 may be configured to display predetermined indication information (referred to as “default indication information”, below) in a predetermined area (referred to as a “default area”, below) on the display 160 as an indication to the user. However, when displaying the predetermined indication information on the display 160, the indication control unit 114 adjusts the indication information so that an operation from the user on the operational area currently shown on the display 160, on which the operation should be received from the user, is not hindered by the indication information.

Specifically, if no operational area exists in the default area, the indication control unit 114 can display default indication information in the default area as it is. On the other hand, if an operational area exists in the default area, the indication control unit 114 adjusts the default indication information. Here, adjustment of the default indication information includes adjustment of the appearance of the default indication information, and adjustment of the function. Adjustment of the appearance of the default indication information includes differentiating the position, the size, and/or the form; differentiating the display method and the output method; deferring the indication; and canceling the indication. The adjustment method storage unit 144 stores the adjustment methods of the default indication information. The indication control unit 114 refers to the adjustment method storage unit 144 to adjust the default indication information. Specific examples of the adjustment methods of the default indication information will be described later.

When displaying the indication information, the indication control unit 114 indicates the displaying to the operational area detection unit 116. Note that “when displaying the indication information the indication” does not mean a period during which the indication information is already displayed actually, but a moment when the indication information is going to be displayed after an event has occurred, with which the indication information needs to be displayed.

In response to the indication from the indication control unit 114, the operational area detection unit 116 has the display process unit 110 detect positions and sizes of respective operational areas currently shown on the display 160. Specifically, the operational area detection unit 116 refers to the screen information storage unit 140, searches for information about display elements included in the screen currently shown on the display 160, and based on the functions and the like of the display elements, detects whether each of the display elements is an operational area. If the information about the display elements is stored in a tree structure as described above, the operational area detection unit 116 can search for information about all of the display elements by using the tree structure.

For example, for an application program, the developer can determine what functions are attached to the display elements. Therefore, if an application program is developed assuming that a method of an indication control according to the embodiment is used, each display element can be set to have information associated that represents whether the display element is an operational area. In this case, the operational area detection unit 116 can determine whether each display element is an operational area, based on the information representing whether it is an operational area.

The operational area detection unit 116 may be configured to determine, for example, button elements such as the various operational buttons, input elements such as input boxes, text having link information attached, and the like as operational areas among display elements described above.

Also, for example, for an OS and the like, with which the assumption about development may not be applicable, or the information representing whether it is an operational area is not associated, the operational area detection unit 116 may determine whether each display element is an operational area, based on, for example, information about standard classes and properties attached to an operational display element. The operational area detection unit 116 may include a storage unit (not illustrated) to store information about standard classes and properties that are determined as operational areas, and can determine whether a display element is an operational area, by comparing the information about the classes and properties stored in the storage unit, with the information about the classes and properties attached to the display element.

Also, in the embodiment, the operational area detection unit 116 may detect that an entire screen is an operational area if an interactive operation is executed on the user terminal device 100 by the user who performs a touch operation or the like at an arbitrary position on the screen, which may be a game screen or the like shown on the display 160. Also, on such a game screen that is entirely operational and shown on the display 160, if an operation on the entire screen is invalidated, for example, by a suspend button being pressed, the operational area detection unit 116 may not determine that the entire screen is an operational area, but may detect only a partial operational area that is still valid.

Once detecting an operational area, the operational area detection unit 116 obtains the position and size of the operational area, and stores them in the detection area storage unit 142. The operational area detection unit 116 can store the positions and sizes of all detected operational areas in the detection area storage unit 142.

The indication control unit 114 refers to the detection area storage unit 142, and determines whether an operational area exists in the default area, based on the positions and sizes of the operational areas detected by the operational area detection unit 116. As described above, if an operational area does not exist in the default area, the indication control unit 114 displays the default indication information; or if an operational area exists in the default area, the indication control unit 114 adjusts the default indication information so that an operation from the user in the operational area is not hindered by the default indication information.

Next, a specific example will be described in which the indication control unit 114 adjusts the default indication information.

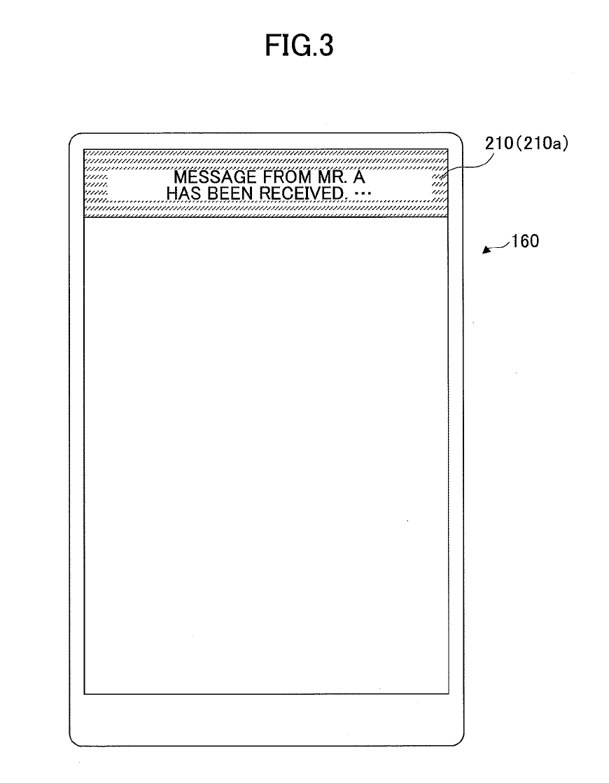

FIG. 3 is a diagram that illustrates an example of default indication information 210 that is displayed in a default area 210a on the display 160 according to the embodiment. Here, it is assumed that the indication control unit 114 displays the default indication information 210 on the display 160 for a certain time, and upon a touch operation or the like on the default indication information 210 by the user, stops displaying the default indication information 210. For example, the default indication information 210 includes the background displayed in the default area 210a, and characters displayed on the background, such as “Message from Mr. A has been received.” As another example, the indication control unit 114 may be configured to control displaying a screen of an application relevant to the indication, upon a touch operation or the like on the default indication information 210 by the user. For example, in the example illustrated in FIG. 3, if the user operates on the default indication information 210, the indication control unit 114 may activate an application program for message reception and transmission to display “Message from Mr. A”.

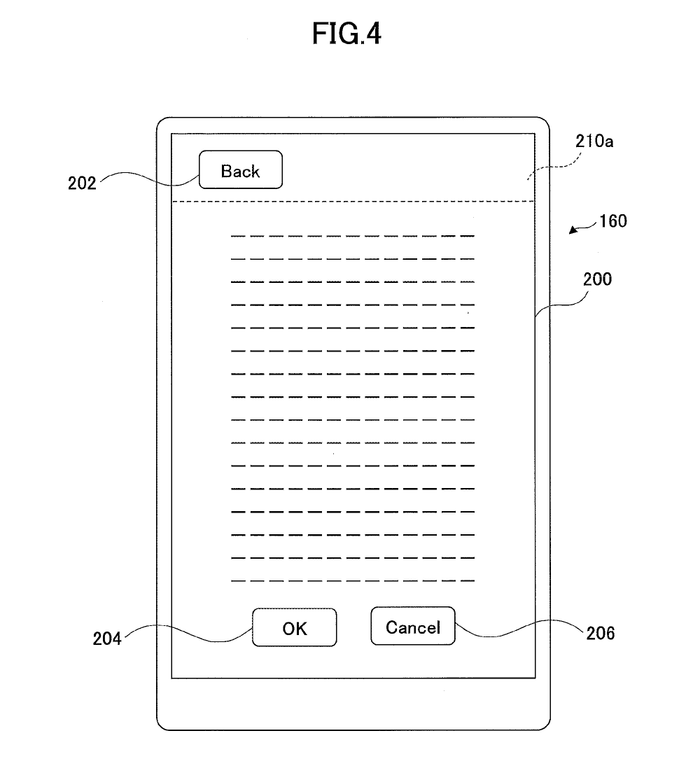

FIG. 4 is a diagram that illustrates an example of a display screen 200 displayed on the display 160 according to the embodiment. The display screen 200 includes, as operational areas, a back button 202 (shown as “Back” in the figure), an OK button 204, and a cancel button 206 (shown as “Cancel” in the figure). Here, the back button 202 as the operational area exists in the default area 210a.

In this case, the indication control unit 114 adjusts the default indication information 210 illustrated in FIG. 3. For example, the indication control unit 114 may adjust the default indication information 210 so that the back button 202 as the operational area can be seen by the user, and displays the adjusted indication information along with the back button 202. Also, in this case, if the back button 202 is operated by the user while the adjusted indication information is displayed, the indication control unit 114 adjusts the default indication information 210 so that an operation on the back button 202 by the user is effective.

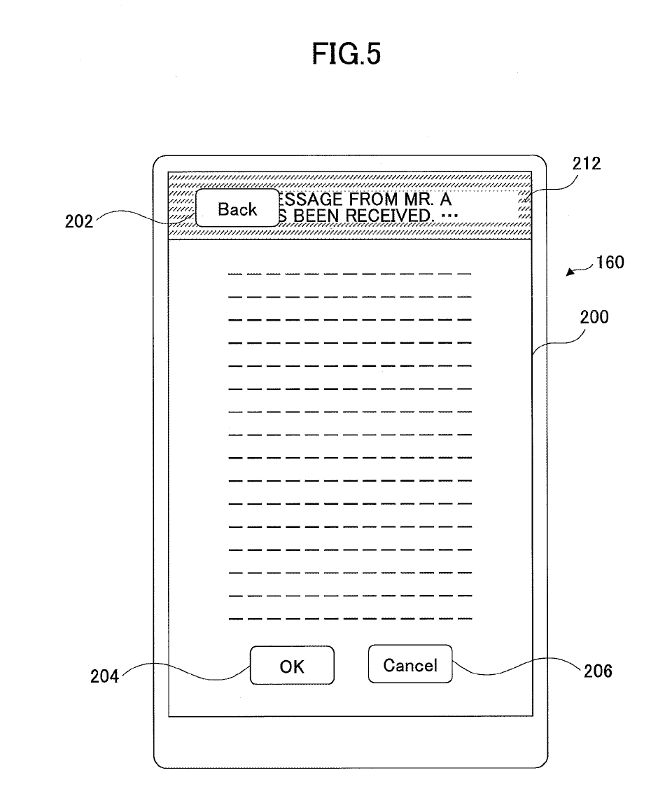

FIG. 5 is a diagram that illustrates an example of adjusted indication information 212 adjusted by the indication control unit 114. The indication control unit 114 adjusts the default indication information 210 so that the default indication information 210 does not overlap the back button 202. Specifically, the indication control unit 114 selectively removes (hollows out) a part of the default indication information 210 overlapping the back button 202, to generate the adjusted indication information 212, places the back button 202 in the adjusted indication information 212, and displays these together on the display 160.

In this configuration, for example, if the user operates on the adjusted indication information 212, the operation reception unit 112 receives it as the same operation as an operation on the default indication information 210. On the other hand, if the user operates on the back button 202 surrounded by the adjusted indication information 212, the operation reception unit 112 receives it as an operation on the adjusted indication information 212.

### Modified Example 1

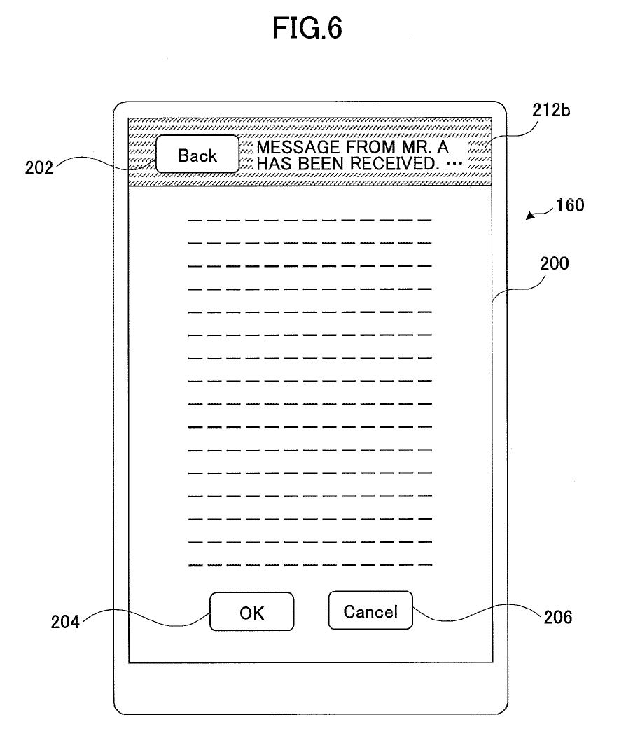

FIG. 6 is a diagram that illustrates another example of adjusted indication information 212b adjusted by the indication control unit 114. Here, in the same way as described with FIG. 5, the indication control unit 114 selectively removes the part of the default indication information 210 overlapping the back button 202, shifts the positions of the characters of the default indication information 210 so that the characters do not overlap the back button 202, to generate the adjusted indication information 212b, places the back button 202 in the adjusted indication information 212, and displays these together on the display 160.

### Modified Example 2

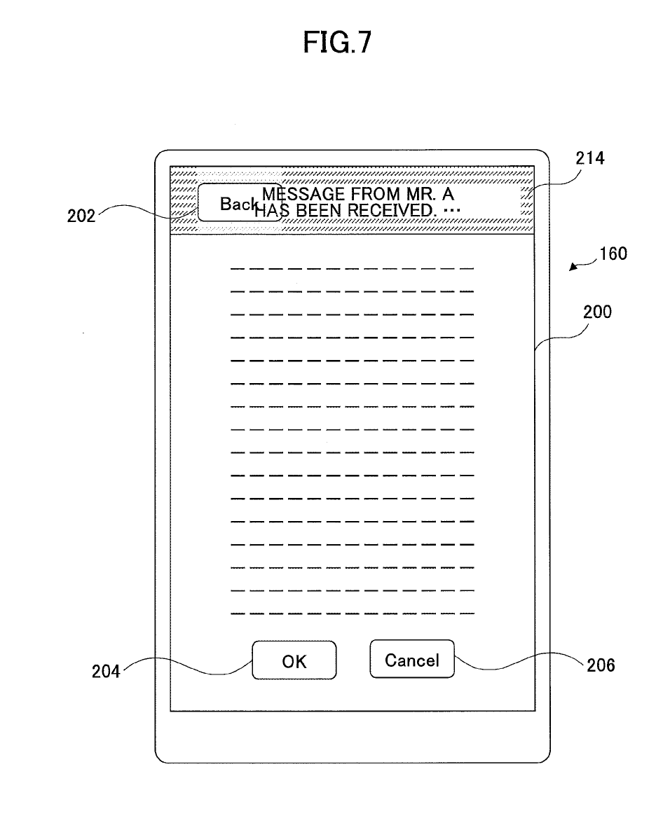

FIG. 7 is a diagram that illustrates another example of adjusted indication information 214 adjusted by the indication control unit 114. Here, the indication control unit 114 generates adjusted indication information 214 in which the part of the default indication information 210 overlapping the back button 202 has gradation of higher transparency, and displays the adjusted indication information 214 having the back button 202 overlapped on the display 160. For example, based on the position of the back button 202, the indication control unit 114 may set gradation for transparency on the default indication information 210 centered around the center position of the back button 202 so that the user can see the back button 202. In this example, the indication control unit 114 can display the adjusted indication information 214 overlapping the back button 202. Therefore, on the part of the adjusted indication information 214 corresponding to the back button 202, some of the characters of “Message from Mr. A . . . ” are displayed, for example, in a semitransparent state.

Also in this configuration, for example, if the user operates on an area of the adjusted indication information 214 not overlapping the back button 202, the operation reception unit 112 receives it as the same operation as an operation on the default indication information 210. On the other hand, if the user operates on the part corresponding to the back button 202, the operation reception unit 112 receives it as an operation on the adjusted indication information 214. In other words, in the examples illustrated in FIG. 5 and FIG. 7, both the function and the appearance of the default indication information 210 are adjusted.

### Modified Example 3

The indication control unit 114 may be also configured to adjust only the function of the default indication information 210 while maintaining the appearance as it is, so that an operation on the area of the default indication information 210 overlapping the back button 202 is received (effective) as an operation on the back button 202, but invalidated as an operation on the default indication information 210. The indication control unit 114 may display the default indication information 210 overlapping the back button 202 on the display 160, and adjusts the default indication information 210 so that if the user operates on the area of the default indication information 210 overlapping the back button 202, the operation is effective as an operation on the back button 202.

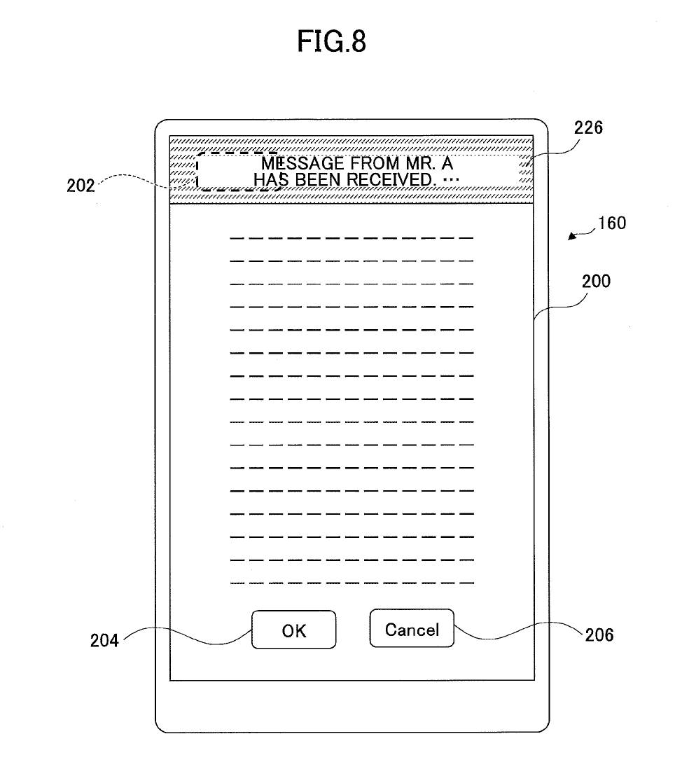

FIG. 8 is a diagram that illustrates another example of adjusted indication information 226 adjusted by the indication control unit 114. The area surrounded by a dashed line in the figure is an area where the back button 202 is to be displayed. Although the adjusted indication information 226 illustrated in FIG. 8 looks like the default indication information 210, it is adjusted so that if the user operates on the area overlapping the back button 202, the operation is effective as an operation on the back button 202.

Configured in this way, for example, if the user is looking over the display screen illustrated in FIG. 4, touches the back button 202, and at that moment, the adjusted indication information 226 is displayed to have the user touch the adjusted indication information 226, it is possible to process the user operation as an operation on the back button 202.

### Modified Example 4

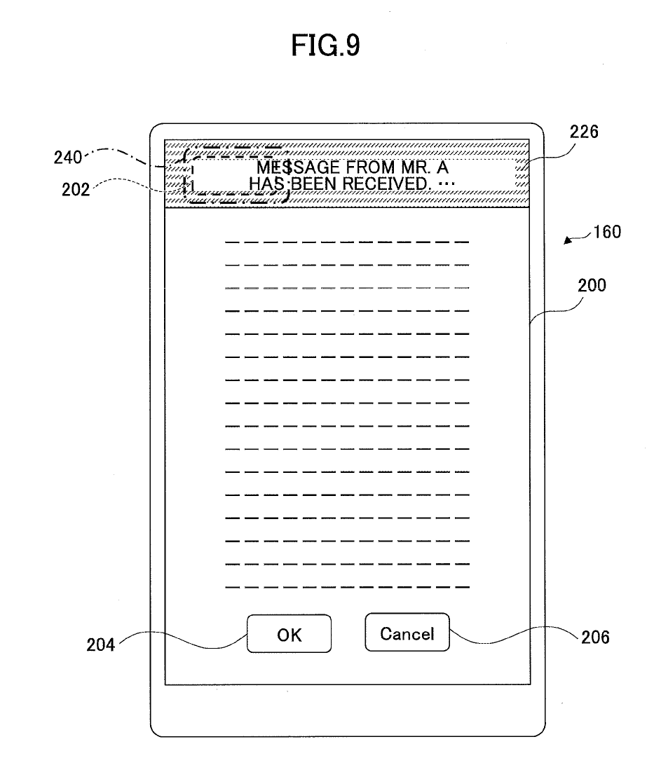

Note that in this case, the indication control unit 114 may adjust not only the area overlapping the back button 202, but also a predetermined area around the back button 202 so that if the user operates on the predetermined area, the operation is effective as an operation on the back button 202. FIG. 9 illustrates this example. If the user operates on an area surrounded by a dotted dashed line 240 that includes the area around the back button 202, the indication control unit 114 adjusts it so that the operation is effective as an operation on the back button 202. Configured in this way, even if the user operation is a bit shifted out of the back button 202, it is possible to process the user operation as an operation on the back button 202.

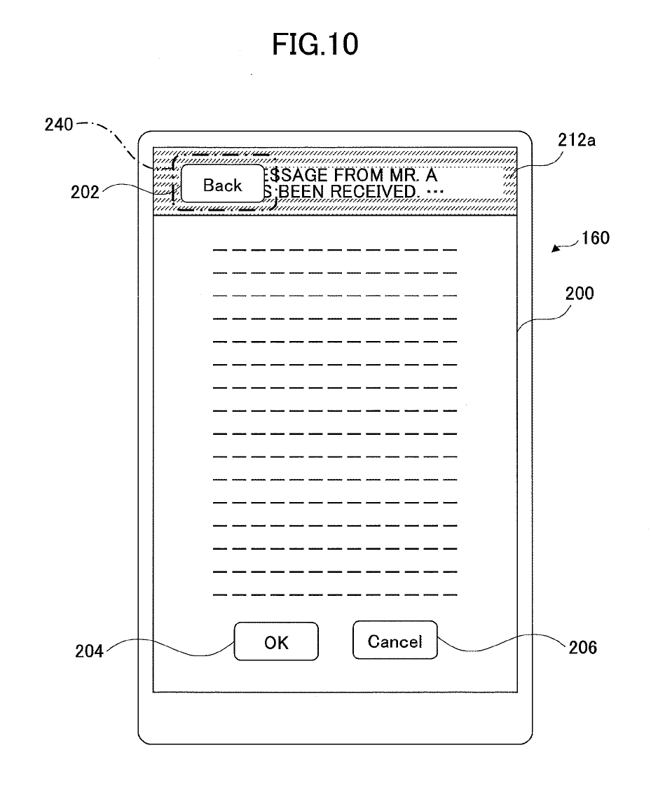

The example illustrated in FIG. 5 may be adjusted similarly; the indication control unit 114 may adjust not only the area where the back button 202 is displayed, but also the predetermined area around the back button 202 so that if the user operates on the predetermined area, the operation is effective as an operation on the back button 202. FIG. 10 illustrates this example. Although the adjusted indication information 212a in FIG. 10 looks like the adjusted indication information 212 illustrated in FIG. 5, it has a wider area than the back button 202, in which an operation is recognized as an operation on the back button 202.

Configured in this way, the display area for contents of the indication to be displayed in the adjusted indication information 212a can be larger, and even if the user operation is a bit shifted out of the back button 202, it is possible to process the user operation as an operation on the back button 202. The example illustrated in FIG. 7 may be adjusted similarly (not illustrated).

### Modified Example 5

Further, as another example, the indication control unit 114 may change the position to display the indication information so as to prevent the indication information from overlapping an operational area, may change the size and shape of the indication information, and may change the way to output the indication information.

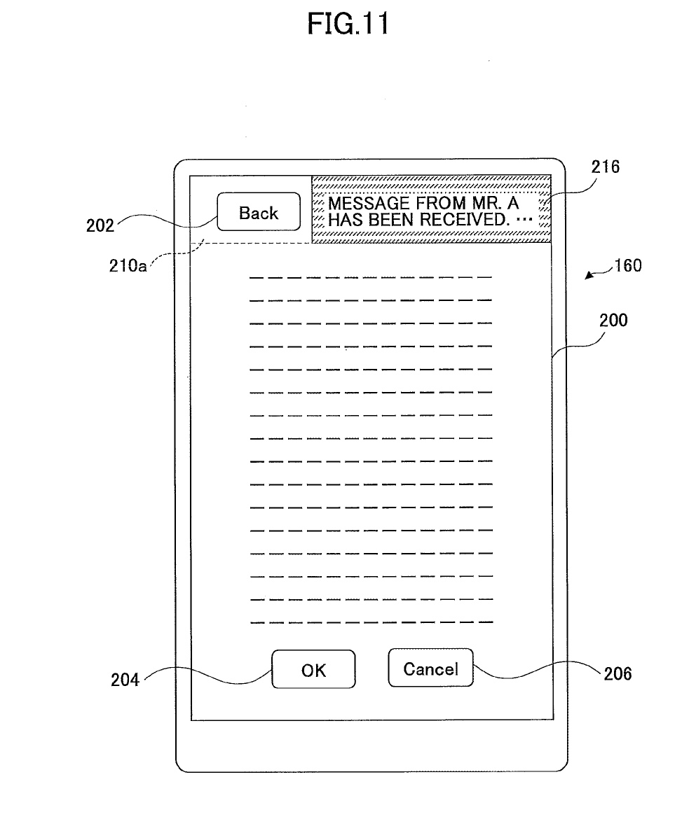

For example, if an operational area such as the back button 202 or the like exists in the default area 210a, the indication control unit 114 may change the size and shape of the indication information so that the indication information is displayed in an area where no operational area exists, and displays the adjusted indication information on the display 160. FIG. 11 is a diagram that illustrates another example of adjusted indication information 216 adjusted by the indication control unit 114. In the example illustrated in FIG. 11, the adjusted indication information 216 whose size is reduced to have a shape not overlapping the back button 202 is displayed in the default area 210a. Based on the positions and sizes of the operational areas detected by the operational area detection unit 116, the indication control unit 114 can detect an area in the default area 210a where the operational areas are not displayed, adjusts the default indication information 210 to have the size fit for the area, and generates the adjusted indication information 216.

### Modified Example 6

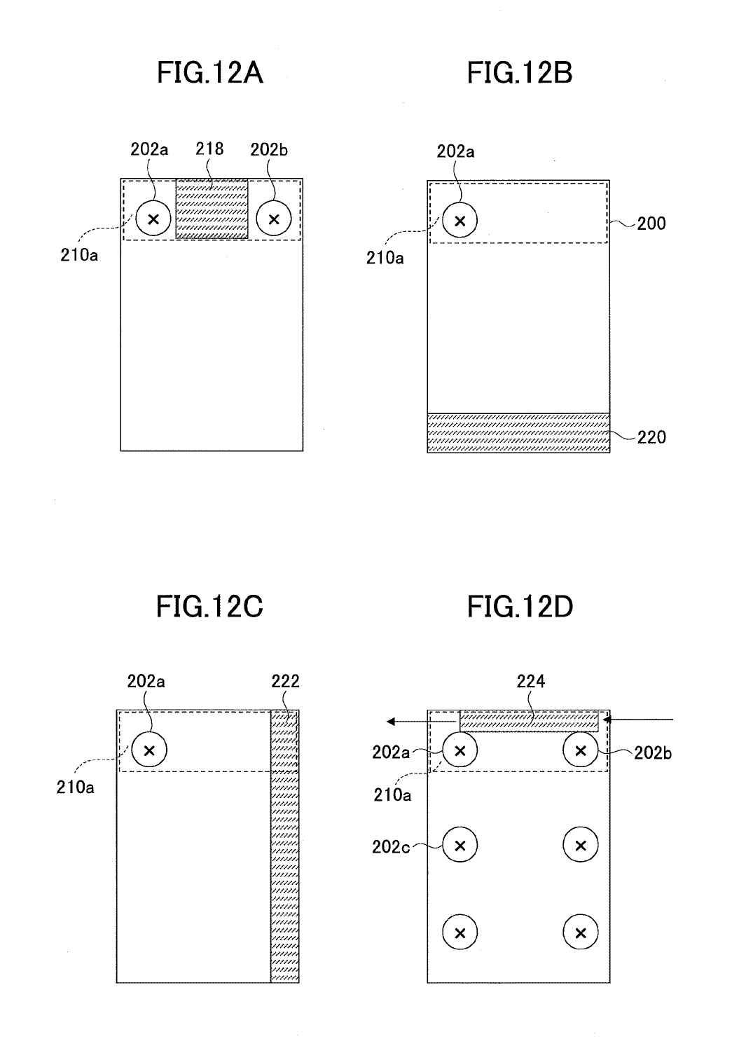

FIGS. 12A-12D are diagrams that illustrate other examples of adjusted indication information adjusted by the indication control unit 114. As illustrated in FIG. 12A, if multiple operational areas (buttons 202a and 202b) exist in the default area 210a, to avoid overlapping these, the indication control unit 114 may display adjusted indication information 218 adjusted to have the size smaller than that of the default indication information in the default area 210a.

### Modified Example 7

Also, if an operational area exists in the default area 210a, the indication control unit 114 may move the indication information to another area on the display 160 where no operational area exists, and displays the indication information. FIG. 12B illustrates this example. As illustrated in FIG. 12B, if an operational area (a button 202a) exists in the default area 210a, the indication control unit 114 can display the adjusted indication information 220 in another area where no operational area exists. The adjusted indication information 220 may have the same appearance as the default indication information 210 as illustrated in FIG. 3, and only the placed position may be set different. Although the adjusted indication information 220 is displayed at the lower part on the screen in FIG. 12B, the position is not limited to the lower part, but may be any position on the screen as long as no operational area exists.

### Modified Example 8

Further, as illustrated in FIG. 12C, if an operational area (a button 202a) exists in the default area 210a, the indication control unit 114 may display the adjusted indication information 220 having the position and direction (or the shape) of the default indication information changed so as not to overlap an operational area.

Also, if the display position of the indication information is changed as illustrated in FIG. 12B and FIG. 12C, yet another operational area exists at the changed position, the indication control unit 114 may adjust the size and shape of the indication information to be reduced appropriately.

### Modified Example 9

Also, based on the operational areas displayed on the display 160, the indication control unit 114 may determine whether there is a sufficient area on the display 160 to display contents to be displayed as the default indication information 210. If a sufficient area is not available for the displaying, the indication control unit 114 may adjust the default indication information 210 to be scrolled in a predetermined direction on the display 160, and displays the adjusted indication information on the display 160. For example, if the entire screen is detected as an operational area on a game screen or the like described above, the indication control unit 114 can determine that no sufficient area is available for the displaying. Also, for example, based on the size of the default indication information, if an available area only has the size less than a predetermined ratio, for example, 50% relative to the size of the default indication information, the indication control unit 114 may determine that no sufficient area is available for the displaying.

FIG. 12D illustrates this example. For example, as illustrated in FIG. 12D, if no sufficient space is available to prevent the indication information from overlapping operational areas for the displaying on the display screen 200, such as a case where operational areas (buttons 202a-202c, etc.) spread over the entire screen, the indication control unit 114 may display the adjusted indication information 224 by scrolling it in a predetermined direction, for example, from the right to the left. Note that in this case, the adjusted indication information 224 may be set as a non-operational element with which no interactive operation is executed even if a touch operation or the like is performed. In addition, if an operation is detected on an operational area that exists on the background screen while the adjusted indication information 224 is scrolling, the indication control unit 114 may process it as an effective operation on the operational area.

### Modified Example 10

Also, if no sufficient space is available to prevent the indication information from overlapping operational areas for the displaying, such as the case where the operational areas spread over the entire screen, the indication control unit 114 may output the indication information by sound, not by displaying. In this case, the indication control unit 114 outputs the indication information as sound information via the sound output process unit 118.

### Modified Example 11

Further, if no sufficient space is available to prevent the indication information from overlapping operational areas for the displaying, such as the case where the operational areas spread over the entire screen, the indication control unit 114 may defer displaying the indication information, monitors the state of the screen, and when the sufficient space becomes available to prevent the indication information from overlapping the operational areas, displays the indication information.

### Modified Example 12

Further, if no sufficient space is available to prevent the indication information from overlapping operational areas for the displaying, such as the case where the operational areas spread over the entire screen, the indication control unit 114 may be configured to stop indicating the information. For example, as described with the modified example 11, if the indication control unit 114 has deferred displaying the indication information, monitors the state of the screen, yet no sufficient space is available to prevent the indication information from overlapping the operational areas even after a predetermined time has passed, the indication control unit 114 may stop indicating the information.

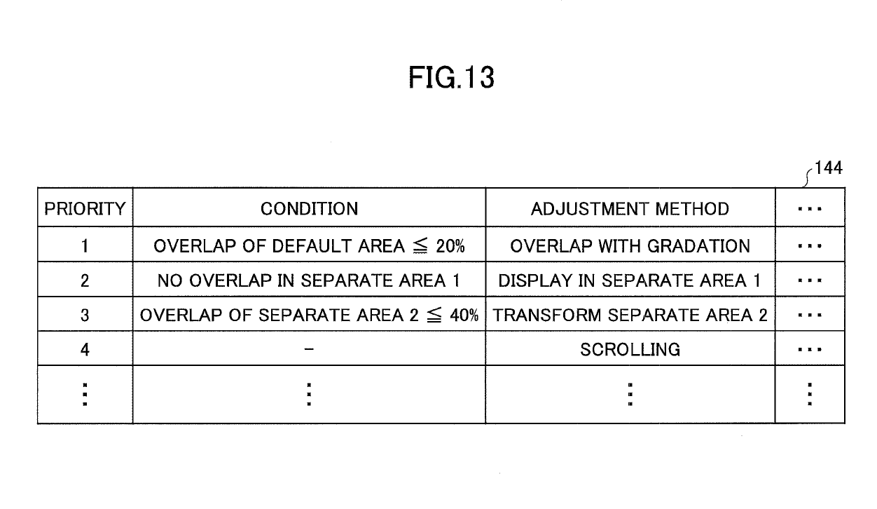

FIG. 13 is a diagram that illustrates an example of an internal configuration of the adjustment method storage unit 144.

The adjustment method storage unit 144 includes information items of “priority”, “condition”, and “adjustment method”. The “adjustment method” represents an adjustment method, which may be one of those described with reference to FIG. 3 to FIG. 12. The “condition” represents a condition to execute the adjustment method. The “priority” is information that represents the priority of an adjustment method to determine which adjustment method is to be executed if multiple adjustment methods are stored in the adjustment method storage unit 144.

The indication control unit 114 refers to the adjustment method storage unit 144, determines whether the condition is satisfied for each of the adjustment methods in order by the priority, and if the condition is satisfied, adopts the adjustment method. For example, in the example illustrated in FIG. 13, an adjustment method “overlap with gradation” is stored, having the priority “1” and the condition “overlap of default area 20%”. In this case, the indication control unit 114 determines whether the overlap between the default indication information and the operational area is less than or equal to 20% of the default area. If the overlap is less than or equal to 20% of the default area, the indication control unit 114 generates the adjusted indication information 214 as described with reference to FIG. 7, and displays the adjusted indication information 214 overlapping operational areas such as the back button 202.

On the other hand, if the overlap is over 20% of the default area, the indication control unit 114 does not adopt the adjustment method having the priority “1”, and determines whether the condition of an adjustment method having the priority “2” is satisfied. As the method having the priority “2”, the adjustment method “display in separate area 1” is stored with the condition “no overlap in separate area 1”. In this case, before displaying the default indication information in a separate area 1, the indication control unit 114 determines whether there is an operational area in the separate area 1. If there is no overlap (no operational area in the separate area 1), the indication control unit 114 generates, for example, the adjusted indication information 220 as described with reference to FIG. 12B, and displays it in the separate area 1 (on the lower part of the display screen 200).

Note that the priorities of the adjustment methods illustrated in FIG. 13 may be set in order, for example, desired by the user. In this case, the indication control unit 114 can receive the setting from the user, to store it in the adjustment method storage unit 144.

Also, the adjustment methods illustrated in FIG. 13 may be provided, for example, for respective applications. For example, for an application program whose operational areas are arranged in a specific pattern, an adjustment method of moving the indication information into an area where no operational area is placed, may be prioritized.

Also, the default area described above may be set to be differentiated, for example, by applications. For example, for an application program whose operational areas are arranged in a specific pattern, the default area may be set to be disposed in an area where no operational area is placed.

Also, the position to which the indication information is moved may not be stored in the adjustment method storage unit 144 with the priority, for example, but may be determined in steps for detecting an area for the displaying, among areas examined sequentially from the upper part of the display 160.

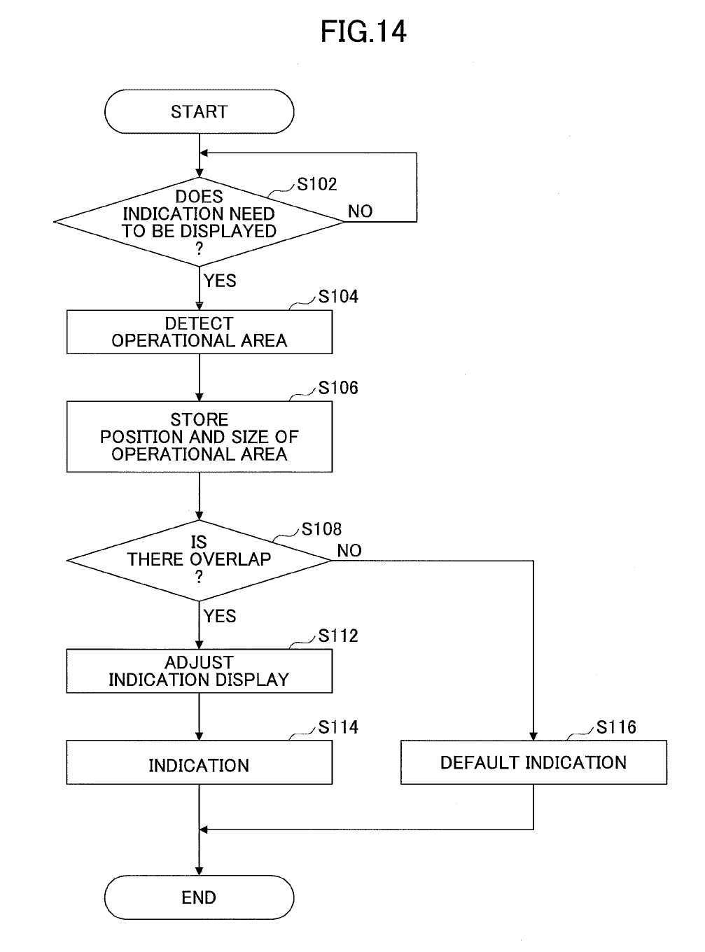

Next, processing steps of the user terminal device 100 will be described according to the embodiment. FIG. 14 is a flowchart that illustrates an example of processing steps of the user terminal device 100 according to the embodiment.

It is assumed here that under control of the control unit 102, information about a screen currently displayed on the display 160 by the display process unit 110 is stored in the screen information storage unit 140.

If the indication control unit 114 determines that indication information needs to be displayed (YES at Step S102), the indication control unit 114 indicates it to the operational area detection unit 116. The operational area detection unit 116 refers to the screen information storage unit 140, and detects operational areas included in the screen currently shown on the display 160 (Step S104). The operational area detection unit 116 stores the positions and sizes of the detected operational areas in the detection area storage unit 142 (Step S106).

The indication control unit 114 refers to the detection area storage unit 142, and determines whether an operational area exists that overlaps the default area where the default indication information is to be displayed (Step S108). If such an operational area does not exist (NO at Step S108), the indication control unit 114 displays the default indication information (Step S116).

On the other hand, if an operational area exists at Step S108 (YES at Step S108), the indication control unit 114 refers to the adjustment method storage unit 144, adjusts the default indication information by the set adjustment method (Step S112), and indicates the adjusted indication information (Step S114).

Note that if determining at Step S102 that the indication information needs to be displayed (YES at Step S102), the indication control unit 114 may determine whether the user terminal device 100 is in an active state (whether the screen is being displayed), and if the user terminal device 100 is not active (the screen is not displayed), goes forward to Step S116, and displays the default indication information as it is.

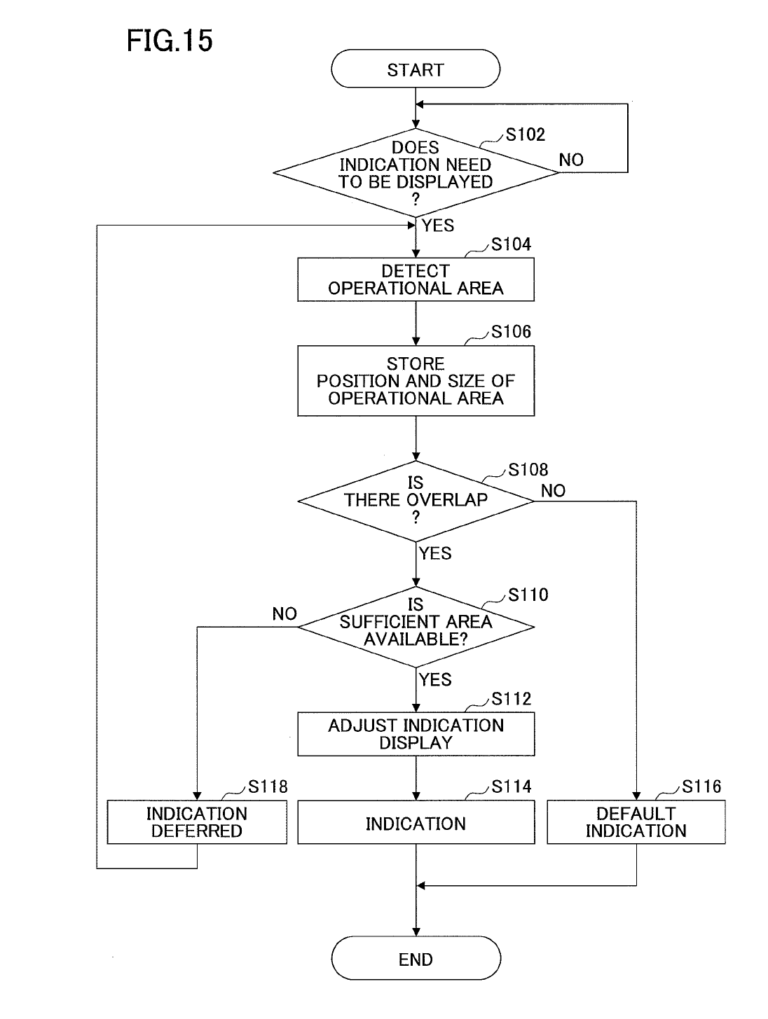

Also, based on the operational areas displayed on the display 160, the indication control unit 114 may determine whether there is a sufficient area to display the contents to be displayed as the default indication information 210 on the display 160. If no sufficient area for the displaying is available, the indication control unit 114 may defer displaying the indication information, and repeatedly determines whether there is a sufficient area to display the contents of the indication information for a predetermined number of times. FIG. 15 is a diagram that illustrates such an example. In FIG. 15, the same steps as in FIG. 14 are assigned the same step numbers, and their description will be omitted appropriately.

At Step S108, if an overlapping operational area exists (YES at Step S108), the indication control unit 114 determines whether there is a sufficient area to display the contents of the indication information (Step S110). If there is a sufficient area to display the contents of the indication information (YES at Step S110), the indication control unit 114 goes forward to Step S116 as in FIG. 14, and executes the same processing.

On the other hand, if there is no sufficient area to display the contents of the indication information (NO at Step S110), the indication control unit 114 defers indicating the indication information (Step S118), goes back to Step S104, and repeats the same steps.

Note that while repeating the same steps, if the entire screen continues to be an operational area even after a predetermined time has passed since the indication has been deferred, for example, the indication control unit 114 may indicate the indication information by sound, may record it as a log, or may stop the indication.

As described above, if a screen displayed on the display 160 is a game screen or the like, and an operation is possible on the entire screen, the indication control unit 114 determines at Step S110 that there is no sufficient area to display the contents of the indication information. Even in this case, for example, if the user presses the suspend button to invalidate an operation on the entire screen, the indication control unit 114 determines at Step S110 that there is a sufficient area to display the contents of the indication information. Therefore, configured in this way, depending on a state of the user operation, for example, at a timing when the user suspends the game, the indication information can be displayed, without hindering the user operation, and the indication can be executed effectively.

The method of controlling indication according to the embodiment can avoid a problem of operational hindrance such that when the user is about to perform an operation on one of the operational areas while using the user terminal device 100, the operational area cannot be seen due to indication information.

Also, for example, even if the indication information is displayed at the moment when the user performs a touch operation or the like on one of the operational areas, the operation on the operational area can be properly recognized, and an operation intended by the user is not hindered.

Note that the present invention is not limited to the configurations described in the embodiments and those combined with the other elements. These can be changed within the scope of the present invention, and can be appropriately defined depending on usage.

In the above embodiments, examples assume that the display 160 is a touch-sensitive display (a touch panel), and the display 160 is an integrated part of the user terminal device 100. However, the display 160 may be configured to be separate from the user terminal device 100. Also, it may be configured to have an operation unit separate from the display. In this case, the operation reception unit 112 may receive input from the user via the operation unit as an operation.

Also, in the above embodiments, examples assume that the operation reception unit 112 receives a touch operation or the like on the display 160. However, the operation reception unit 112 may be configured to receive finger pointing, a command by a pointer, and a line of sight as operations from the user. In other words, the above embodiments are applicable to a user terminal device that can recognize a user operation performed by finger pointing, a line of sight, and the like.

Further, as described above, if an application program is developed assuming that a method of controlling indication according to the above embodiments is used, each display element can be set to have information associated that represents whether the display element is an operational area. In this case, each of the operational areas may be set with a setting to prevent the operational area from being hindered by the indication information, and the priority. In this case, the indication information may be adjusted to be effective only for operational areas having the setting to prevent the operational areas from being hindered by the indication information, or having higher priorities, so as not to be hindered by the indication information.

Configured in this way, for example, the indication information may be adjusted only for those operational areas that have high operational frequency by the user, and are preferably not hindered by the indication information. This makes it is possible to prevent an operation intended by the user from being hindered while securing convenience of the indication.

Note that the elements of the user terminal device 100 illustrated in FIG. 2 are not hardware units, but functional blocks. These blocks of the user terminal device 100 are implemented by a combination of hardware and software on any computer that may include a CPU, a memory, a program loaded in the memory that implements the blocks in the figures, a storage unit such as a hard disk to store the program, and a network connection interface. Also, it should be understood by one skilled in the art that various modification can be made in terms of implementation and devices.

Thus, the embodiments of the present invention have been described with reference to the drawings. It should be noted that these are examples of the present invention, and various configurations other than the above can be adopted.

The present application is based on and claims the benefit of priority of Japanese Priority Application No. 2015-182021, filed on Sep. 15, 2015, the entire contents of which are hereby incorporated by reference.

1. A method of controlling indication, executed by a user terminal device when displaying predetermined indication information on a display unit showing an operational area on which an operation from a user can be received, the method comprising:
adjusting the indication information so as to prevent the operation from the user on the operational area, from being hindered by the indication information.

2. The method of controlling indication as claimed in claim 1, wherein the indication information is configured to be displayed in a predetermined default area of the display unit,
wherein the adjusting adjusts the indication information when the operational area exists in the default area.

3. The method of controlling indication as claimed in claim 1, wherein the adjusting adjusts the indication information so that the operational area can be seen by the user, and then, displays adjusted indication information having been adjusted on the display unit, along with the operational area.

4. The method of controlling indication as claimed in claim 3, wherein the adjusting selectively removes a part of the indication information overlapping the operational area, to generate the adjusted indication information, and then, displays the adjusted indication information on the display unit, along with the operational area.

5. The method of controlling indication as claimed in claim 3, wherein the adjusting generates the adjusted indication information so as to make the part of the indication information overlapping the operational area have higher transparency, and then, displays the adjusted indication information on the display unit, along with the operational area.

6. The method of controlling indication as claimed in claim 3, wherein in response to detecting a user operation on an area corresponding to the operational area, in a state where the adjusted indication information is displayed on the display unit along with the operational area, the adjusting adjusts the indication information so as to make the operation effective as the operation on the operational area, to generate the adjusted indication information.

7. The method of controlling indication as claimed in claim 1, wherein in response to detecting a user operation on an area of the indication information overlapping the operational area, in a state where the indication information is displayed on the display unit along with the operational area, the adjusting adjusts the indication information so as to make the operation effective as the operation on the operational area, to display the indication information.

8. The method of controlling indication as claimed in claim 2, wherein when the operational area exists in the default area, the adjusting displays the indication information in an area on the display unit where the operational area does not exist.

9. The method of controlling indication as claimed in claim 2, wherein when the operational area exists in the default area, the adjusting adjusts a size of the indication information so as to be displayed in the area where the operational area does not exist, and displays adjusted indication information having been adjusted on the display unit.

10. The method of controlling indication as claimed in claim 2, wherein when the operational area exists in the default area, the adjusting adjusts the indication information so as to be display information scrolling in a predetermined direction on the display unit, or to be sound information, to generate adjusted indication information, and indicates the adjusted indication information having been adjusted.

11. The method of controlling indication as claimed in claim 1, wherein the adjusting determines, based on the operational area displayed on the display unit, whether there is an area on the display unit in which the indication information can be displayed, and if determining that there is no area in which the indication information can be displayed, defers or stops displaying the indication information.

12. The method of controlling indication as claimed in claim 1, wherein the indication information is configured to be capable of receiving an operation from the user.

13. The method of controlling indication as claimed in claim 1, the method further comprising:
detecting a position and a size of the operational area currently displayed on the display unit when displaying the indication information,
wherein the adjusting adjusts the indication information, based on the position and the size of the operational area detected by the detecting.

14. A user terminal device, comprising:
an indication control unit configured, when displaying predetermined indication information on a display unit showing an operational area on which an operation by a user can be received, to adjust the indication information so as to prevent the operation from the user on the operational area, from being hindered by the indication information.

15. A non-transitory computer-readable recording medium having a program stored therein for causing an information processing apparatus to execute a process of controlling indication when displaying predetermined indication information on a display unit showing an operational area on which an operation by a user can be received, the process comprising:
adjusting the indication information so as to prevent the operation from the user on the operational area, from being hindered by the indication information.
